(19) United States
(12) Patent Application Publication
(10) Pub. No.: US 2024/0340881 A1
(43) Pub. Date: Oct. 10, 2024

(54) TWT BASED MULTI-AP COOPERATION

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/601,940

(22) Filed: Mar. 11, 2024

Related U.S. Application Data
(60) Provisional application No. 63/458,030, filed on Apr. 7, 2023.
(60) Provisional application No. 63/458,033, filed on Apr. 7, 2023.

(51) Int. Cl. H04W 72/12

(52) U.S. Cl. CPC H04W 72/12

(57) ABSTRACT

A first access point (AP) device receives information related to a target wake time (TWT) schedule established in a second basic service set (BSS). The second BSS is established by the second AP device. The first AP device shall ensure that a transmission opportunity (TXOP) established in a first BSS ends before a start time of a TWT service period of the TWT schedule established in the second BSS. The first BSS is established by the first AP device.

### CROSS-REFERENCE TO RELATED APPLICATIONS

This application claims the benefit of priority from U.S. Provisional Application No. 63/458,030, entitled “TWT-BASED MULTI-AP COOPERATION MECHANISM,” filed Apr. 7, 2023; U.S. Provisional Application No. 63/458,033, entitled “NEGOTIATION PROCEDURES FOR TWT-BASED MULTI-AP COOPERATION,” filed Apr. 7, 2023, all of which are incorporated herein by reference in their entirety.

### TECHNICAL FIELD

This disclosure relates generally to a wireless communication system, and more particularly to, for example, but not limited to, multi-AP coordination in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first access point (AP) device in a wireless network. The AP device comprises a memory, and a processor coupled to the memory. The processor is configured to cause receiving information related to a target wake time (TWT) schedule established in a second basic service set (BSS), wherein the second BSS is established by a second AP device, and ensuring that a transmission opportunity (TXOP) established in a first BSS ends before a start time of a TWT service period of the TWT schedule established in the second BSS. The first BSS is established by the first AP device.

In some embodiments, the processor is further configured to cause abstaining from transmitting a frame to any station associated with the first AP device in the first BSS during the TWT service period.

In some embodiments, the processor is further configured to cause abstaining from transmitting a frame to any station associated with the first AP device in the first BSS after the start time of the TWT service period, and initiating communication with a station associated with the first AP device in a time indicated from the second AP device, wherein the time is before an end time of the TWT service period.

In some embodiments, the TWT schedule established in the second BSS is associated with communication of latency sensitive traffic.

In some embodiments, the process is further configured to cause abstaining from transmitting a frame to any station associated with the first AP device in the first BSS after the start time of the TWT service period, receiving a trigger frame to solicit a response frame from the second AP device, and initiating communication with a station associated with the first AP device before an end time of the TWT service period.

In some embodiments, the processor is further configured to cause receiving a request frame for multi-AP coordination from the second AP device, and transmitting a response frame indicating acceptance of the request for multi-AP coordination to the second AP device.

In some embodiments, the processor is further configured to cause receiving an announcement frame for the multi-AP coordination from the second AP device, and transmitting a frame indicating capability to participate in the multi-AP coordination to the second AP device.

In some embodiments, information related to the TWT schedule is received from the second AP device.

In some embodiments, the processor is further configured to cause transmitting a TWT element including information for the TWT schedule to one or more stations associated with the first AP device.

In some embodiments, the TWT element includes information indicating that the TWT schedule is established in the second BSS.

In some embodiments, the processor is further configured to cause receiving a request frame for multi-AP coordination from a controller, transmitting a response frame indicating acceptance of the request for multi-AP coordination to the controller, receiving an TWT coordination information including information related to the TWT schedule from the controller, and transmitting an acknowledgement to the controller in response to the TWT coordination information.

One aspect of the present disclosure provides a station in a wireless network. The station comprises a memory, and a processor coupled to the memory. The process is configured to cause receiving a target wake time (TWT) element from a first AP device which is associated with the station, wherein the TWT element includes information indicating that a TWT schedule corresponds to the TWT element is established in a second service set (BSS) established by a second AP device, and ensuring that a transmission opportunity (TXOP) established in a first BSS ends before a start time of a TWT service period of the TWT schedule, wherein the first BSS is established by the first AP device.

In some embodiments, the processor is further configured to cause abstaining from transmitting a frame to the first AP device during the TWT service period.

In some embodiments, the processor is further configured to cause abstaining from transmitting a frame to the first AP device after the start time of the TWT service period, and initiating communication with the first AP device in a time indicated from the first AP device. The time is before an end time of the TWT service period.

In some embodiments, the processor is further configured to cause abstaining from transmitting a frame to the first AP device after the start time of the TWT service period, and initiating communication with the first AP device when a trigger frame to solicit a response frame is received from the first AP device before an end time of the TWT service period.

In some embodiments, the TWT schedule established in the second BSS is associated with communication of latency sensitive traffic.

One aspect of the present disclosure provides a first access point (AP) device in a wireless network. The AP device comprises a memory, and a processor coupled to the memory. The processor is configured to cause transmitting a request frame for multi-AP coordination to a second AP device, wherein the request frame includes a TWT schedule established in a first basic service set (BSS) and the first BSS is established by the first AP device, and receiving a response frame indicating acceptance of the multi-AP coordination from the second AP device.

In some embodiments, the processor is further configured to cause transmitting an announce frame for the multi-AP coordination to one or more second AP devices, wherein the announce frame includes a mode information for the multi-AP coordination, and receiving a frame indicating capability to participate in the multi-AP coordination from the second AP device.

In some embodiments, the TWT schedule is associated with communication of latency sensitive traffic.

In some embodiments, the processor is further configured to cause transmitting a trigger frame to the second AP device before an end time of a TWT service period corresponding to the TWT schedule. The trigger frame indicates that the second AP is allowed to initiate communication with an associated station in the second BSS.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of individual TWT operation in accordance with an embodiment.

FIG. 5 shows an example of broadcast TWT operation in accordance with an embodiment.

FIG. 6 shows an example of a broadcast TWT operation in accordance with an embodiment.

FIG. 7 shows an example of an individual TWT negotiation between an AP MLD and a non-AP MLD in accordance with an embodiment.

FIGS. 8A to 8C show an example that illustrates interference from neighboring BSS in accordance with an embodiment.

FIG. 9 shows an example of multi-AP coordination in accordance with an embodiment.

FIG. 10 shows an example of Mode-1 R-TWT multi-AP coordination in accordance with an embodiment.

FIG. 11 shows an example of Mode-2 R-TWT multi-AP coordination in accordance with an embodiment.

FIG. 12 shows an example operation of Mode-5 R-TWT multi-AP coordination in accordance with an embodiment.

FIG. 13 shows an example format of the TWT element in accordance with an embodiment.

FIG. 14 shows a flow chart of an example operation of multi-AP coordination in accordance with an embodiment.

FIG. 15 shows an example architecture for coordinated TWT negotiation in accordance with an embodiment.

FIG. 16 shows an example of Type-1 architecture for C-TWT negotiation in accordance with an embodiment.

FIG. 17 shows another example of Type-1 architecture for C-TWT negotiation in accordance with an embodiment.

FIG. 18 shows a flow chart of an example operation of TWT multi-AP coordination in accordance with an embodiment.

FIG. 19 shows an example of Type-2 architecture for C-TWT negotiation in accordance with an embodiment.

FIG. 20 shows an example timing diagram of Type-2 architecture for C-TWT negotiation in accordance with an embodiment.

FIG. 21 shows a flow chart of an example operation of TWT multi-AP coordination in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

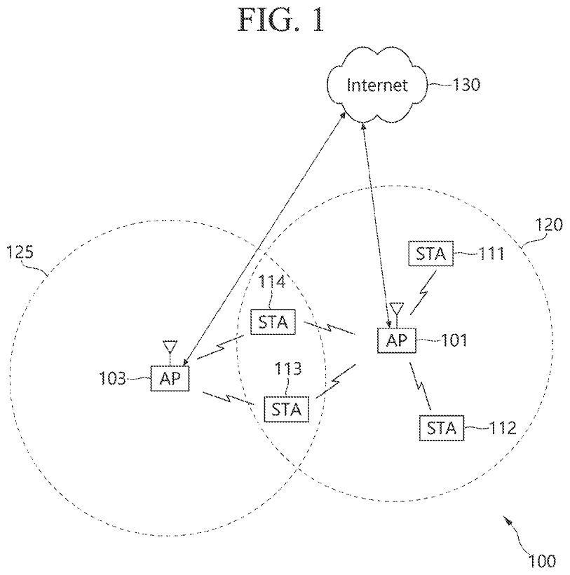

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

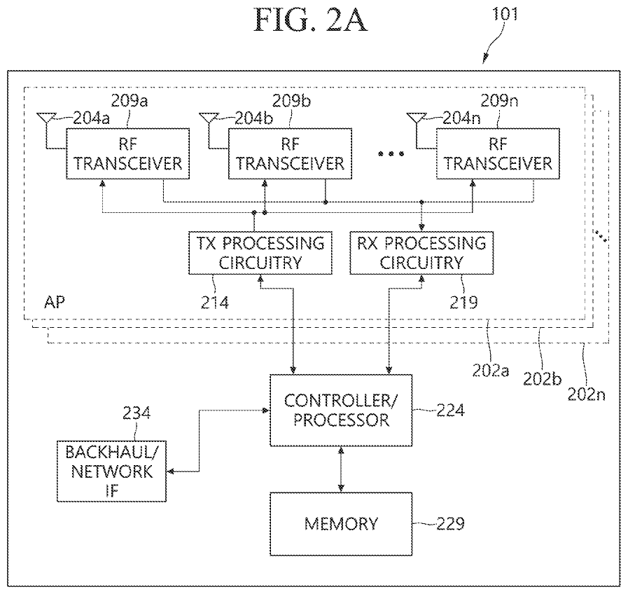

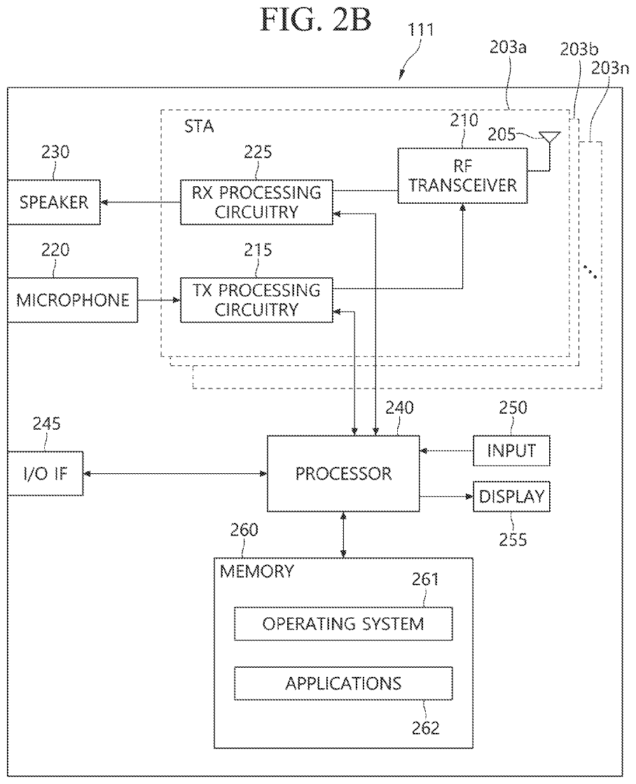

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

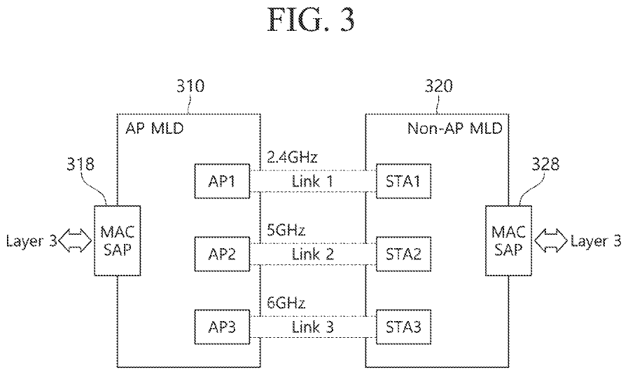

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It may be achieved by allocating STAs to operate at non-overlapping times or frequencies and perform the frame exchange sequences in pre-scheduled service periods. In TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

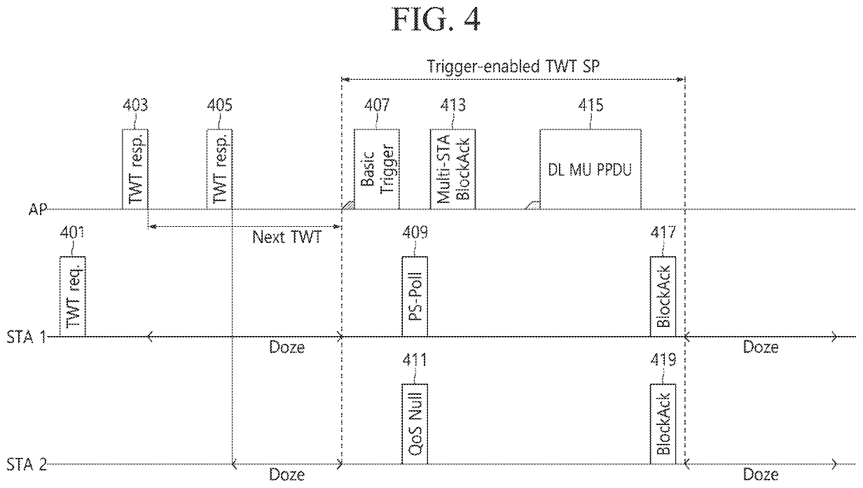

FIG. 4 shows an example of individual TWT operation in accordance with an embodiment. The operation depicted in FIG. 4 is for illustration purposes and does not limit the scope of this disclosure to any particular implementations.

In FIG. 4, STA 1 and STA 2 are TWT requesting STAs and AP is a TWT responding STA. In the example of FIG. 4, STA 1 sends a TWT request 401 to AP to setup a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a Basic Trigger frame 407 to the TWT requesting STAs (STA 1 and STA 2) which may indicate that they are awake during the TWT SP. STA 1 indicates that it is awake by sending a PS (power save)-Poll frame 409, and STA 2 indicates that it is awake by sending QoS (quality of service) Null frame 411 in response to the Basic Trigger frame 407. Subsequently, the AP sends a Multi-STA Block Ack 413 frame and DL MU (downlink multi-user) PPDU 415 to both STA 1 and STA 2. Afterward, STA 1 and STA 2 respectively send BlockAck frames 417 and 419 to the AP, and then go to doze state.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

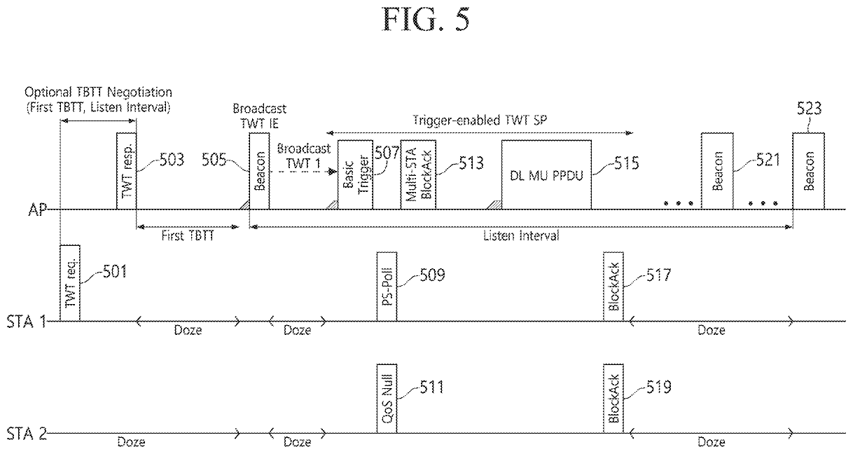

FIG. 5 shows an example of broadcast TWT operation in accordance with an embodiment. The operation depicted in FIG. 5 is for illustration purposes and does not limit the scope of this disclosure to any particular implementations.

In FIG. 5, STA 1 and STA 2 are TWT scheduled STAs and AP is a TWT scheduling AP. In the example of FIG. 5, STA 1 and AP may have optional TBTT (target beacon transmission time) negotiation by exchanging TWT request frame 501 and TWT response frame 503. After the first TBTT, the AP sends a beacon frame 505 including a broadcast TWT element that indicates a broadcast TWT SP. During the TWT SP, the AP may send trigger frames, or downlink buffer-able units (BUs) to the TWT scheduled STAs (STA 1 and STA 2). STA 1 and STA 2 wake to receive the beacon frame 505 to determine the broadcast TWT. During the trigger-enabled TWT SP, the AP sends a basic trigger frame 507 to STA 1 and STA 2 which indicate that they are awake during the TWT SP. STA 1 indicates that it is awake by sending a PS-Poll frame 509, while STA 2 indicates that it is awake by sending a QoS Null frame 511 in response to the basic trigger frame 507. STA 1 and STA 2 receive their DL BUs in a subsequent frame exchange (e.g., Multi-STA BlockAck 513, DL MU PPDU 515, and BlockAck 517 and 519) with the AP and go to doze state out of the TWT SP. After the TWT SP, the AP sends beacon frames 521 and 523 periodically to STA 1 and STA 2. As illustrated, the AP can advertise/announce and maintain multiple broadcast TWT schedules in the BSS. When a change is made to any of the broadcast TWT schedules, it may affect all STAs that are members of the particular TWT schedule.

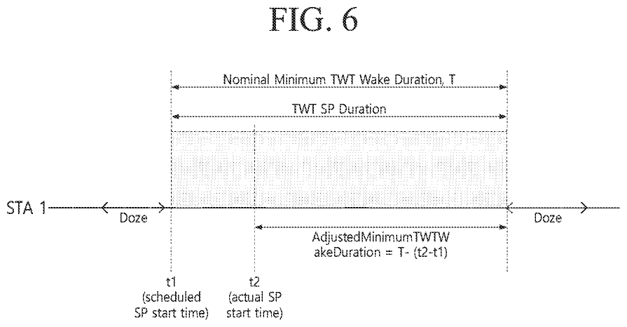

FIG. 6 shows an example of a broadcast TWT operation in accordance with an embodiment. The operation depicted in FIG. 6 is for illustration purposes and does not limit the scope of this disclosure to any particular implementations.

In FIG. 6, STA 1 establishes a broadcast TWT schedule with STA 1. STA 1 is a TWT scheduled STA and AP (not shown in FIG. 6) is an associated TWT scheduling AP. In this disclosure, the TWT scheduled STA is a STA that follows the broadcast TWT schedules provided in a broadcast TWT element. The TWT scheduling AP is an AP that schedules broadcast TWTs and provides these broadcast TWT schedules in a broadcast TWT element. In the broadcast TWT parameter set field of the broadcast TWT element, t1 is the value of the target wake time indicated in the target wake time field in the broadcast TWT parameter set field of the broadcast TWT element. Therefore, t1 is the ideal time for STA 1 to initiate a frame exchange sequence with AP 1. Starting from t1, the time duration that STA 1 is required to remain awake may be the value of nominal wake time duration (T) indicated in the nominal minimum TWT wake duration field in the Broadcast TWT Parameter Set field. In some implementations, STA 1 may not be able to initiate the frame exchange sequence with AP 1 at the nominal SP start time 11, and actual SP start time may be much later. In the example of FIG. 6, the actual SP start time is indicated as 12. Consequently, due to the delayed actual SP start time, the minimum wake duration for STA 1 may be adjusted, denoted as ‘AdjustedMinimumTWTWakeDuration=T−(t2−t1).’

In the individual TWT agreement between multi-link devices (MLDs) that supports multi-link operation, a STA affiliated with an MLD, which is a TWT requesting STA, may indicate the links that are requested for setting up TWT agreements in the link ID bitmap subfield of a TWT element in the TWT request frame. When only one link is indicated in the link ID bitmap subfield, a single TWT agreement is requested for the STA affiliated with the MLD, which operates on the indicated link. The target wake time field of the TWT element may be in reference to the TSF (timing synchronization function) time of the link indicated in the TWT element. Subsequently, a TWT responding STA affiliated with a peer MLD, which receives the TWT request, may respond with a TWT response that indicates the links in a link ID bitmap subfield of a TWT element. The links in the TWT element of the TWT response may be the same as the links indicated in the TWT element of the TWT request.

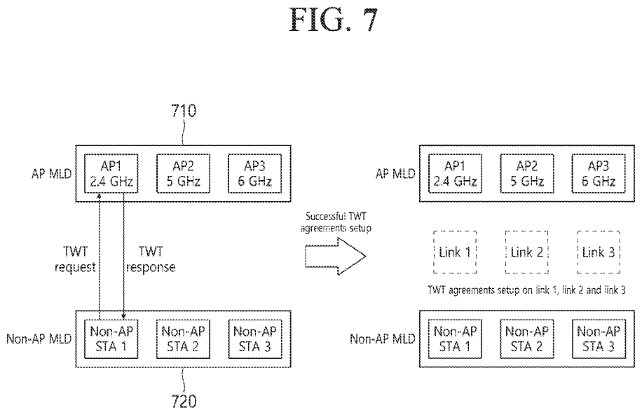

FIG. 7 shows an example of an individual TWT negotiation between an AP MLD and a non-AP MLD in accordance with an embodiment. The operation depicted in FIG. 7 is for illustration purposes and does not limit the scope of this disclosure to any particular implementations.

In FIG. 7, AP 1, AP 2, and AP 3 are affiliated with AP MLD 710. Non-AP STA 1, Non-AP STA 2, and Non-AP STA 3 arc affiliated with Non-AP MLD 720. In some implementations, AP 1 and non-AP STA 1 operate on 2.4 GHz band, AP 2 and non-AP STA 2 operate on 5 GHz band, and AP 3 and non-AP STA 3 operate on 6 GHz band. The non-AP STA 1 affiliated with the non-AP MLD 720 may send three TWT elements in a TWT request to the AP 1 affiliated with the AP MLD 710 for three TWT agreements. The three TWT elements indicate the links of AP 1, AP 2, and AP 3, respectively, with the request of three TWT agreements to be setup on three links. The three TWT agreements may have different TWT parameters, such as target wake up time and a value of demand TWT in the TWT setup command field. Subsequently, the AP 1 sends three TWT elements in a TWT response to the non-AP STA 1. The three TWT elements indicate the links of AP 1, AP 2, and AP 3, respectively, and have different TWT parameters, such as a value of accept TWT in the TWT setup command field. After successful TWT agreement setup on the three links, there exist three TWT SPs with different TWT parameter on the three links.

Restricted TWT (R-TWT) operation is another important feature for the next generation WLAN. The R-TWT operation provides better support for latency sensitive applications. For instance, traffic in real time applications has stringent requirements in terms of latency and its jitter along with certain reliability constraint. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Interference from one BSS may often lead to performance issues for STAs and APs in neighboring BSSs. This interference may result in overall throughput degradation in the network. The Overlapping BSS (OBSS) interference may also increase the overall latency since it takes more time to access the channel due to the interference occupying the channel. If a STA in a BSS has latency-sensitive traffic, this delay in channel access may significantly impede the performance of the STA's latency-sensitive applications.

When a STA in a BSS is an R-TWT scheduled STA and the STA has latency-sensitive traffic, the R-TWT scheduled STA may not be able to access the channel during the R-TWT SP due to the interference, even if any on-going TXOP by other STAs in its BSS ends before the R-TWT SP starts. This can disrupt the delivery of latency-sensitive traffic of the STA.

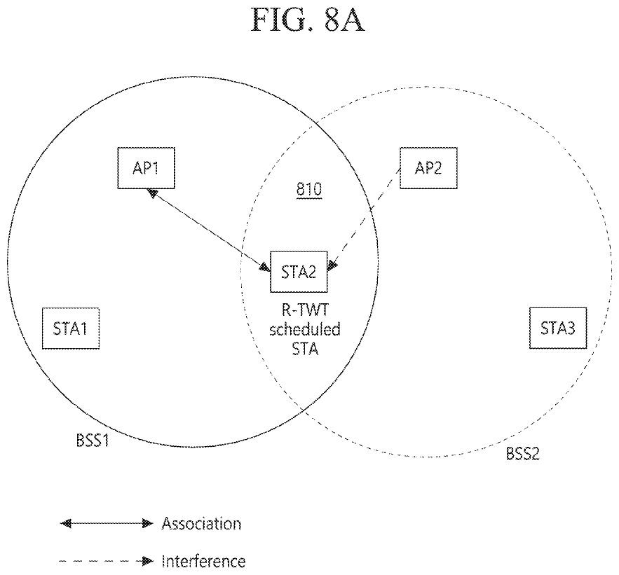

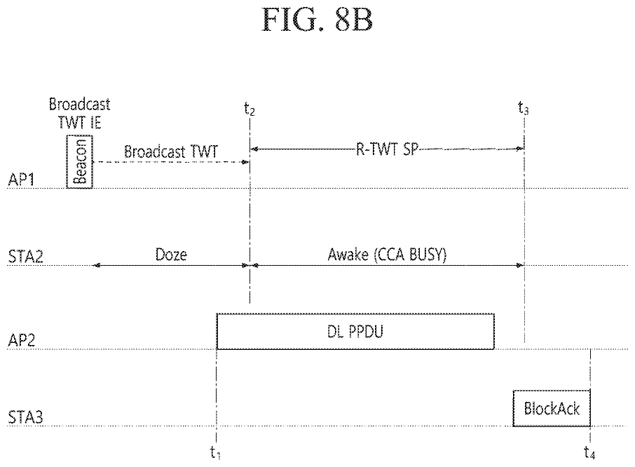

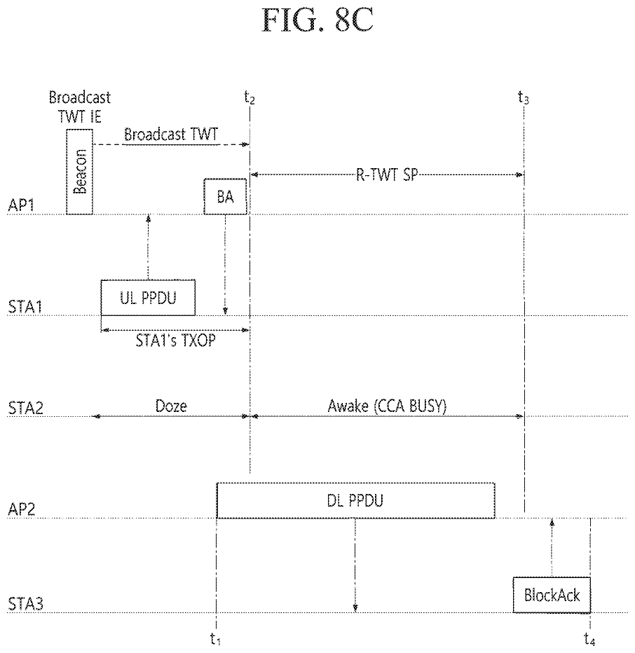

FIGS. 8A to 8C show an example that illustrates interference from neighboring BSS in accordance with an embodiment. The examples depicted in FIGS. 8B and 8C are based on the scenario shown in FIG. 8A.

FIG. 8A shows an example scenario of OBSS interference in accordance with an embodiment. In FIG. 8A, AP 1 establishes BSS 1 and AP 2 establishes BSS 2. BSS 1 and BSS 2 overlap, making them overlapping BSS (OBSS) to each other. STA 1 and STA 2 are associated with AP 1, while STA 3 is associated with AP 2. In the example of FIG. 8A, AP 1 is an R-TWT scheduling AP and STA 2 is an R-TWT scheduled STA. STA 2 is located within the overlapping region 810 of BSS 1 and BSS 2. Therefore, as illustrated, STA 2 may experience OBSS interference from BSS 2 when STA 2 attempts to access the channel during the R-TWT SP.

FIG. 8B shows an example timing diagram of OBSS interference in accordance with an embodiment. Referring to FIG. 8B, the R-TWT SP for STA 2 is scheduled to start at time 12 and end at time 13. Meanwhile, AP 2 may commence transmission to STA 3, which is associated with AP 2, at time t1 and continues frame exchanges (e.g., DL PPDU and Bolock Ack frame) until time 14. Consequently, when STA 2 wakes up at time 12, STA 2 observes the channel as busy due to the transmission from AP 2 to STA 3, and the channel remains busy throughout the scheduled R-TWT SP. As a result, latency-sensitive traffic of the R-TWT schedule STA (STA 2) may not be delivered on schedule, disrupting STA 2's latency-sensitive application. This issue depicted in FIG. 8B may arise because AP 2 and STA 3 do not observe R-TWT rules for the BSS 1.

FIG. 8C shows another example timing diagram of OBSS interference in accordance with an embodiment. Referring to FIG. 8C, STA 1 ends its TXOP before the R-TWT for STA2 starts because both STA 1 and STA 2 are members of BSS 1, with STA 2 being the R-TWT scheduled STA. However, AP 2 does not end the transmission before the start time of the R-TWT for STA 2 because AP 2 is a member of the different BSS (BSS 2).

Therefore, TWT-based multi-AP coordination may be an important feature for next generation WLAN to address the interference issues from OBSS. This disclosure provides concepts and mechanisms of TWT-based multi-AP coordination. Additionally, this disclosure provides how R-TWT operation can be extended or applied to multi-AP coordination, along with operational rules for R-TWT for multi-AP coordination.

Coordination among neighboring APs by sharing a STA's wake-up pattern information may be advantageous for interference management. In an embodiment, the coordinating AP may share TWT information of the STAs in its BSS, which may be referred to as ‘coordinated TWT (C-TWT)’ in this disclosure. This coordination may help in mitigating OBSS interference or enhancing signal power during TWT SP.

In some embodiments, an R-TWT sharing AP may refer to an AP that has an R-TWT schedule in its BSS and initiates a TWT coordination request to another AP. In this disclosure, the ‘R-TWT sharing AP’ may be referred to as ‘TWT sharing AP’ for convenience. If an AP has established an R-TWT schedule in its BSS and solicits assistance from a neighboring AP to protect channel access during its R-TWT SP, the AP is designated as the R-TWT sharing AP. In some embodiments, rather than sending the TWT coordination request to the neighboring AP, the R-TWT sharing AP may send the coordination request to a STA or a group of STAs in a neighboring BSS.

In some embodiments, an R-TWT shared AP may refer to an AP that receives the TWT coordination request from another AP. In this disclosure, the ‘R-TWT shared AP’ may be referred to as ‘TWT shared AP’ for convenience.

In some embodiments, an R-TWT coordinating AP set may refer to a group of APs that coordinate to ensure channel access protection during the R-TWT SP corresponding to R-TWT schedules in any or all of the APs' BSSs.

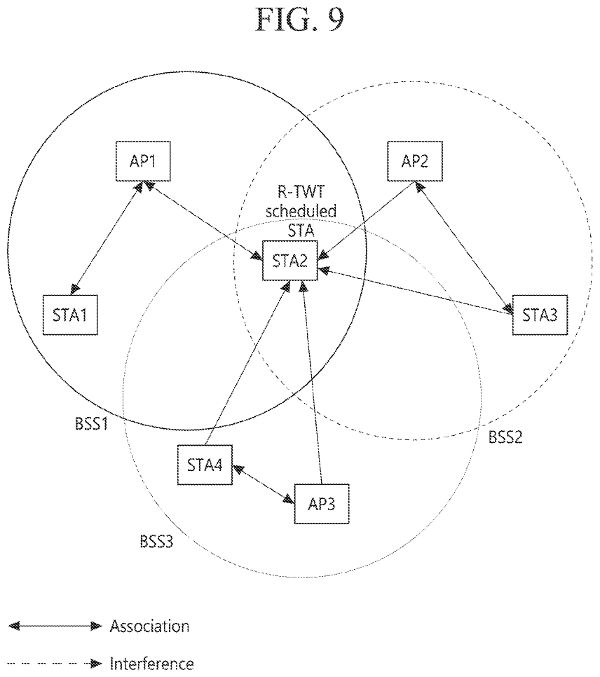

FIG. 9 shows an example of multi-AP coordination in accordance with an embodiment. The scenario and operations depicted in FIG. 9 are for illustration purposes and does not limit the scope of this disclosure to any particular implementations.

In FIG. 9, AP 1 establishes BSS 1, AP 2 establishes BSS 2, and AP 3 establishes BSS 3. STA 1 and STA 2 are associated with AP 1 in BSS 1, STA 3 is associated with AP 2 in BSS 2, and STA 4 is associated with AP 3 in BSS 3. In this example, AP 1 is an R-TWT scheduling AP and STA 2 is an R-TWT scheduled STA in BSS 1. In such a scenario, APs and STAs in each BSS may cause interference to APs and STAs in neighboring BSSs. For instance, APs and STAs in BSS 2 and BSS 3 may cause interference to STA 2. Consequently, AP 1, AP 2, and AP 3 may agree to collaborate in order to protect R-TWT schedules in their BSSs. Therefore, AP1, AP2, and AP3 may collectively form an R-TWT coordinating AP set. In an embodiment, AP1 may solicit assistance from the AP2 and AP3 for protection of the R-TWT schedule in BSS1. In this scenario, AP1 acts as the R-TWT sharing AP, while AP2 and AP3 serve as the R-TWT shared APs within the R-TWT coordinating AP set.

In an embodiment, there may be different levels or modes of multi-AP R-TWT coordination. Some modes of operations are provided below as examples.

In an embodiment, a first AP, which is an R-TWT sharing AP operating in a first BSS, has a first R-TWT schedule established in the first BSS and is also a member of an R-TWT coordinating AP set. Additionally, a second AP operating in a second BSS is also a member of the R-TWT coordinating AP set. In this scenario, i) the second AP and any non-AP STAs associated with the second AP and operating in the second BSS shall ensure the TXOP ends before the start time of an R-TWT SP corresponding to the first R-TWT schedule in the first BSS, and ii) the second AP and any non-STAs associated with the second AP and operating in the second BSS does not transmit a frame during an R-TWT SP corresponding to the first R-TWT schedule in the first BSS. This mode of R-TWT multi-AP coordination may be referred to as ‘Mode-1 R-TWT multi-AP coordination.’

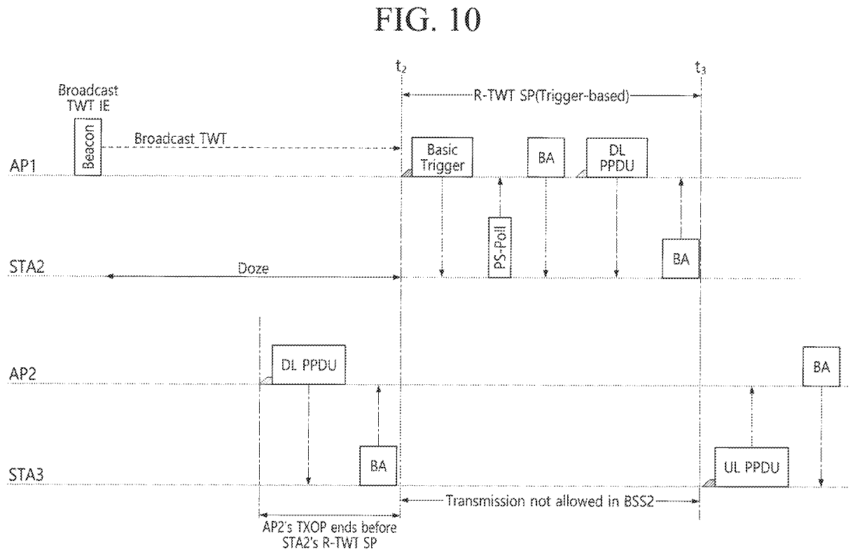

FIG. 10 shows an example of Mode-1 R-TWT multi-AP coordination in accordance with an embodiment. The operation depicted in FIG. 10 is for illustration purposes and does not limit the scope of this disclosure to any particular implementations.

The example depicted in FIG. 10 is based on the scenario shown in FIG. 8A. Therefore, AP 1 establishes BSS 1 and AP 2 establishes BSS 2. BSS 1 and BSS 2 overlap, making them overlapping BSS (OBSS) to each other. STA 1 and STA 2 are associated with AP 1, while STA 3 is associated with AP 2. AP 1 is an R-TWT scheduling AP and STA 2 is an R-TWT scheduled STA in BSS 1. STA 2 is located within the overlapping region 810 of BSS 1 and BSS 2. In this example, AP 1 and AP 2 are members of an R-TWT coordination AP set, while AP 1 is an R-TWT sharing AP and AP 2 is an R-TWT shared AP. Referring to FIG. 10, the R-TWT SP for STA 2 is scheduled to start at time 12 and end at time 13 in BSS 1. The TXOP established between AP 2 and STA 3 in BSS 2 ends before the start time 12 of the R-TWT SP of BSS 1 of which STA 2 is a member. During the R-TWT SP in BSS 1, STA 3 and AP 2 refrain from transmitting a frame in BSS 2. After the end of the R-TWT SP in BSS 1, STA 3 may start contending for uplink PPDU transmission.

In an embodiment, a first AP, which is an R-TWT sharing AP operating in a first BSS, has a first R-TWT schedule established in the first BSS and is also a member of an R-TWT coordinating AP set. Additionally, a second AP operating in a second BSS is also a member of the R-TWT coordinating AP set. In this scenario, i) the second AP and any non-AP STAs associated with the second AP and operating in the second BSS shall ensure the TXOP ends before the start time of an R-TWT SP corresponding to the first R-TWT schedule in the first BSS, and ii) the second AP and any non-STAs associated with the second AP and operating in the second BSS may transmit frames during an R-TWT SP corresponding to the first R-TWT schedule in the first BSS. This mode of R-TWT multi-AP coordination may be referred to as ‘Mode-2 R-TWT multi-AP coordination.’

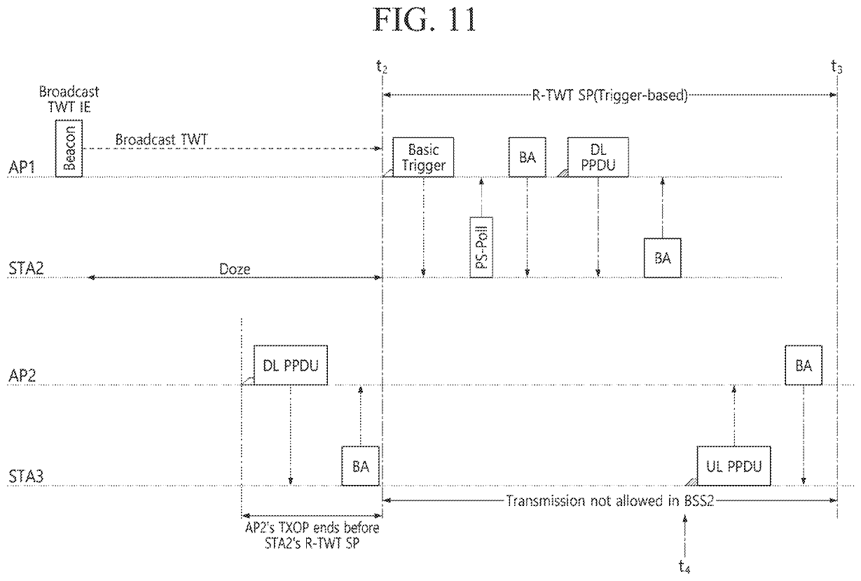

FIG. 11 shows an example of Mode-2 R-TWT multi-AP coordination in accordance with an embodiment.

The example depicted in FIG. 11 is also based on the scenario shown in FIG. 8A. Therefore, AP 1 establishes BSS 1 and AP 2 established BSS 2. BSS 1 and BSS 2 overlap, making them overlapping BSS (OBSS) to each other. STA 1 and STA 2 are associated with AP 1, while STA 3 is associated with AP 2. AP 1 is an R-TWT scheduling AP and STA 2 is an R-TWT scheduled STA in BSS 1. STA 2 is located within the overlapping region 810 of BSS 1 and BSS 2. In this example, AP 1 and AP 2 are members of an R-TWT coordination AP set, while AP 1 is an R-TWT sharing AP and AP 2 is an R-TWT shared AP. Referring to FIG. 11, the R-TWT SP for STA 2 is scheduled to start at time 12 and end at time 13 in BSS 1. The TXOP established between AP 2 and STA 3 in BSS 2 ends before the start time 12 of the R-TWT SP in BSS 1 of which STA 2 is a member. However, AP 2 and STA 3 may transmit frames during the R-TWT SP established in BSS1. In an embodiment, at a time 14 indicated by the target wake time of the R-TWT SP, AP 2 or any associated STAs in BSS 2 may start contending for channel access and transmit frames after winning the contention. In some implementations, at the time 14 indicated by the target wake time of the R-TWT SP, contention by any STAs in BSS1 and BSS 2 can start at the same time. Therefore, contention start time of any STAs in both BSS 1 and BSS 2 can be aligned.

In an embodiment, a first AP, which is an R-TWT sharing AP operating in a first BSS, has a first R-TWT schedule established in the first BSS and is a member of an R-TWT coordinating AP set. Additionally, a second AP operating in a second BSS is also a member of the R-TWT coordinating AP set. In this scenario, i) the second AP and any non-AP STAs associated with the second AP and operating in the second BSS shall ensure the TXOP ends before the start time of an R-TWT SP corresponding to the first R-TWT schedule in the first BSS if the TXOP has not been obtained for low latency traffic, in which case, the TXOP is not needed to be ended, and ii) the second AP and any non-STAs associated with the second AP and operating in the second BSS may transmit frames during an R-TWT SP corresponding to the first R-TWT schedule in the first BSS. This mode of R-TWT multi-AP coordination may be referred to as ‘Mode-3 R-TWT multi-AP coordination.’

In an embodiment, a first AP, which is an R-TWT sharing AP operating in a first BSS, has a first R-TWT schedule established in the first BSS and is a member of an R-TWT coordinating AP set. Additionally, a second AP operating in a second BSS is also a member of the R-TWT coordinating AP set. In this scenario, i) the second AP operating in the second BSS shall ensure the TXOP ends before the start time of an R-TWT SP corresponding to the first R-TWT schedule in the first BSS, and ii) any STAs associated with the second AP and operating in the second BSS may not end its TXOP before the start time of an R-TWT SP corresponding to the first R-TWT schedule in the first BSS. This mode of R-TWT multi-AP coordination may be referred to as ‘Mode-4 R-TWT multi-AP coordination.’

In an embodiment, a first AP, which is an R-TWT sharing AP operating in a first BSS, has a first R-TWT schedule established in the first BSS and is a member of an R-TWT coordinating AP set. Additionally, a second AP operating in a second BSS is also a member of the R-TWT coordinating AP set. In this scenario, i) the second AP operating in the second BSS shall ensure the TXOP ends before the start time of an R-TWT SP corresponding to the first R-TWT schedule in the first BSS, and ii) the second AP or any STAs associated with the second AP and operating in the second BSS may start contention for channel access after being triggered by the first AP. If the second AP or any STAs associated with the second AP receives a trigger frame, the second AP or any STAs associated with the second AP may transmit a frame during the R-TWT SP established in BSS 1. This mode of R-TWT multi-AP coordination may be referred to as ‘Mode-5 R-TWT multi-AP coordination.’

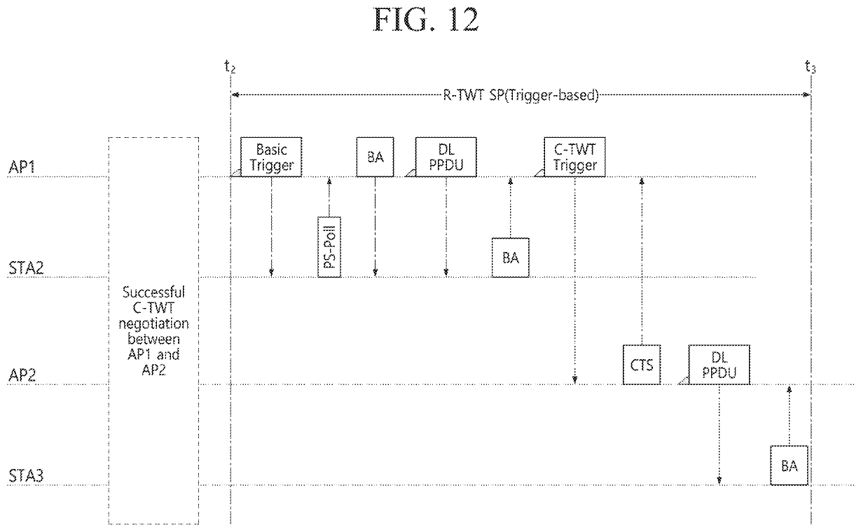

FIG. 12 shows an example operation of Mode-5 R-TWT multi-AP coordination in accordance with an embodiment. The operation depicted in FIG. 12 is for illustration purposes and does not limit the scope of this disclosure to any particular implementations.

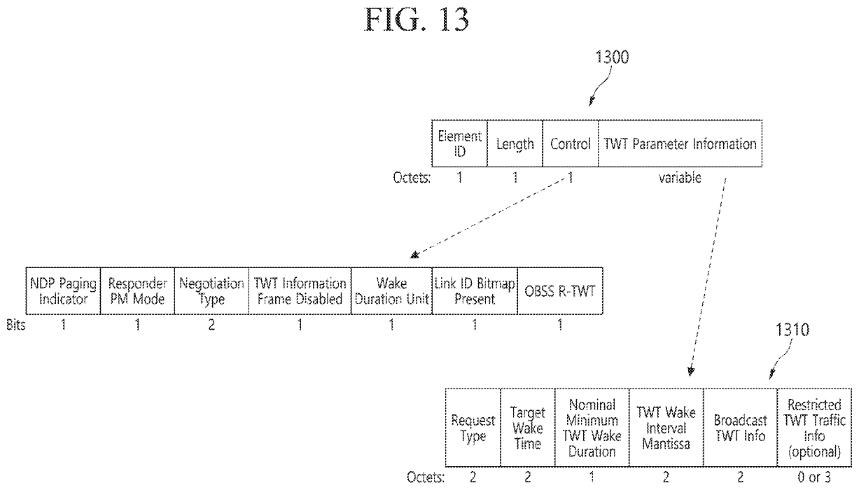

The example depicted in FIG. 12 is also based on the scenario shown in FIG. 8A. Therefore, AP 1 establishes BSS 1 and AP 2 establishes BSS 2. BSS 1 and BSS 2 overlap, making them overlapping BSS (OBSS) to each other. STA 1 and STA 2 are associated with AP 1, while STA 3 is associated with AP 2. AP 1 is an R-TWT scheduling AP and STA 2 is an R-TWT scheduled STA in BSS 1. STA 2 is located within the overlapping region 810 of BSS 1 and BSS 2. In this example, AP 1 and AP 2 are members of an R-TWT coordination AP set, while AP 1 is an R-TWT sharing AP and AP 2 is an R-TWT shared AP. Referring to FIG. 13, AP 1 and AP 2 have successful C-TWT negotiation before the start time of R-TWT SP established between AP 1 and STA 2. AP 2 may end the TXOP (not shown) established between AP 2 and ST 3 before the start time 12 of the R-TWT SP in BSS 1. However, when AP 2 receives a C-TWT trigger from AP 1, AP 2 responds by sending a CTS (clear to send) frame to the AP 1 and start contention for channel access to transmit DL PPDU to STA 3.

In an embodiment, a first AP, which is an R-TWT sharing AP operating in a first BSS, has a first R-TWT schedule established in the first BSS and is a member of an R-TWT coordinating AP set. Additionally, a second AP operating in a second BSS is also a member of the R-TWT coordinating AP set. In this scenario, while advertising the R-TWT schedule in the second BSS, the second AP may indicate that the advertised R-TWT schedule is an OBSS R-TWT schedule. Such an indication may be implemented by setting the OBSS R-TWT subfield in the TWT element.

FIG. 13 shows an example format of the TWT element in accordance with an embodiment.

In FIG. 13, the TWT element 1300 may include an Element identifier (ID) field, a length field, a Control field, and a TWT Parameter Information field. The Element ID field may include information to identify the TWT element 1300. The Length field may indicate a length of the TWT element 1300.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field 520. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field may include one or more Broadcast TWT Parameter Set fields 1310. The Broadcast TWT Parameter Set field 1310 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field includes information of the TWT element. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to compete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a Broadcast TWT ID and a Broadcast TWT Persistence.

In some embodiments, when the OBSS R-TWT subfield in the TWT element is set to ‘1’, there can be another indication in a field or subfield of the TWT element that may indicate the mode of R-TWT multi-AP coordination requested by the neighboring BSS. In some implementations, a three-bit subfield can be used for this indication and the subfield may be referred to as ‘R-TWT Coordination Mode subfield.’ An example encoding of the R-TWT Coordination Mode subfield is shown in Table below.

TABLE 1

| Subfield Value | Encoding |
|---|---|
| 0 | Mode-1 R-TWT Multi-AP coordination |
| 1 | Mode-2 R-TWT Multi-AP coordination |
| 2 | Mode-3 R-TWT Multi-AP coordination |
| 3 | Mode-4 R-TWT Multi-AP coordination |
| 4 | Mode-5 R-TWT Multi-AP coordination |
| 5-7 | reserved |

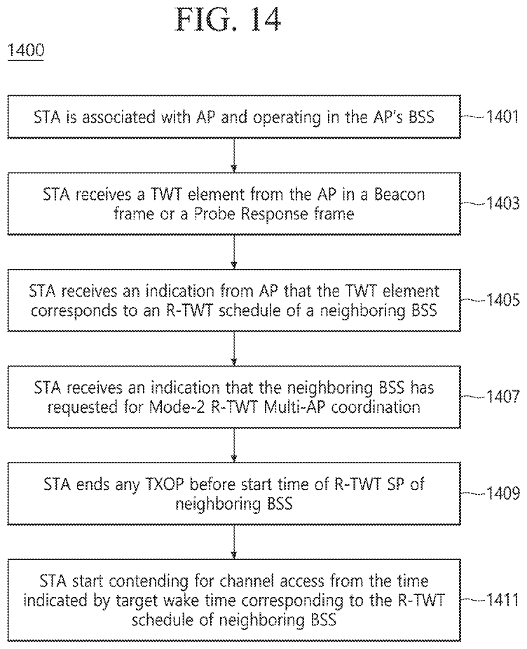

FIG. 14 shows a flow chart of an example operation of multi-AP coordination in accordance with an embodiment. For explanatory and illustration purposes, the example process 1400 may be performed by the STA 3 depicted in FIGS. 8 and 11. Although one or more operations are described or shown in particular sequential order, in other embodiments the operations may be rearranged in a different order, which may include performance of multiple operations in at least partially overlapping time periods.

The process 1400 may begin in operation 1401. In operation 1401, a STA is associated with an AP and operating in the BSS that the AP established.

In operation 1403, the STA receives a TWT element from the AP in a beacon frame or a probe response frame. Then, the process 1400 proceeds to operation 1405.

In operation 1405, the STA receives an indication from the AP that the TWT element corresponds to an R-TWT schedule of a neighboring BSS. In some embodiments, the indication may be included in the OBSS R-TWT subfield in the TWT element.

In operation 1407, the STA also receives an indication that the neighboring BSS has requested a Mode-2 R-TWT Multi-AP coordination.

In operation 1409, the STA ends any TXOP before the start time of the R-TWT SP corresponding to the R-TWT schedule of neighboring BSS.

In operation 1411, the STA starts contending for a channel access at the time indicated by the target wake time corresponding to the R-TWT schedule in the neighboring BSS.

In an embodiment, a first AP may coordinate with a second AP in the vicinity in order to coordinate with the AP's individual TWT agreement, a broadcast TWT schedule, or R-TWT schedule. The coordination mechanism may take different formats based on the architecture of the C-TWT negotiation.

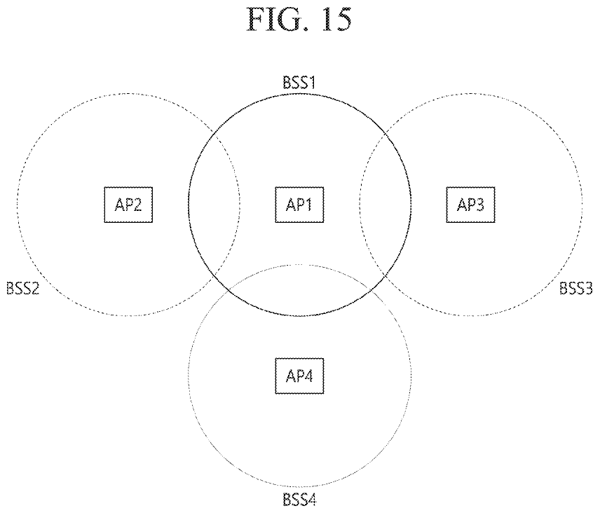

FIG. 15 shows an example architecture for coordinated TWT negotiation in accordance with an embodiment.

In FIG. 15, AP 1, AP 2, AP 3, and AP 4 establish BSS 1, BSS2, BSS 3, and BSS4, respectively. Additionally, AP 1, AP 2, AP 3, and AP 4 are members of an R-TWT coordination AP set and are participating in the TWT multi-AP coordination. In FIG. 15, the APs may be R-TWT scheduling APs in their BSSs. The APs participating in the TWT multi-AP coordination may directly exchange frames among the APs to negotiate the TWT multi-AP coordination. This may be referred to as ‘Type-1 architecture for coordinated TWT (C-TWT) negotiation’ in this disclosure.

In an embodiment of the Type-1 architecture for C-TWT negotiation, a first AP intending to participate in the TWT multi-AP coordination may send a C-TWT request frame to a second AP in its vicinity in order to request the TWT multi-AP coordination. The negotiation for the TWT multi-AP coordination may be initiated by sending the C-TWT request frame, which may include one or more TWT elements indicating the desired TWT schedule. For instance, for R-TWT based multi-AP coordination, the first AP may include a TWT element in the C-TWT request frame which includes one or more broadcast TWT parameter set fields corresponding to the R-TWT schedules. An example format of the C-TWT request frame is shown in Table 2 below.

TABLE 2

| Order | Information |
|---|---|
| 1 | Category |
| 2 | Unprotected S1G Action |
| 3 | Dialog Token |
| 4 | TWT Coordination Mode |
| 5 | One or more TWT |

In an embodiment, the second AP may send a C-TWT response frame to the first AP in response to the C-TWT request frame. If the second AP indicates acceptance of the C-TWT request in the C-TWT response frame, the first AP and the second AP become members of an R-TWT multi-AP coordination set. An example format of the C-TWT response frame is shown in Table 3 below.

TABLE 3

| Order | information |
|---|---|
| 1 | Category |
| 2 | Unprotected S1G Action |
| 3 | Dialog Token |
| 4 | TWT Coordination Mode |
| 5 | One or more TWT |

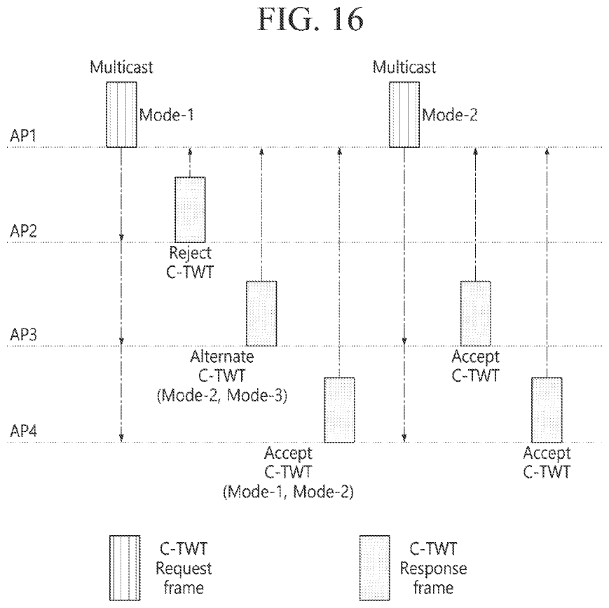

FIG. 16 shows an example of Type-1 architecture for C-TWT negotiation in accordance with an embodiment. The operation depicted in FIG. 16 is for illustration purposes and does not limit the scope of this disclosure to any particular implementations.

In FIG. 16, AP 1 is an R-TWT scheduling AP and sends a C-TWT request frame to AP 2, AP 2, and AP 4, indicating Mode-1 R-TWT multi-AP coordination. In response to the C-TWT request frame, AP 2 rejects the R-TWT coordination request by sending a Reject C-TWT frame to AP 1. AP 3 may not support the Mode-1 R-TWT multi-AP coordination. Therefore, AP 3 sends an Alternate C-TWT frame, indicating the capability to support Mode-2 R-TWT multi-AP coordination and Mode-3 R-TWT multi-AP coordination. Meanwhile, AP 4 accepts the C-TWT request from AP 1 by sending an Accept C-TWT frame indicating its capability to support the Mode-1 R-TWT multi-AP coordination and Mode-2 R-TWT multi-AP coordination.

Subsequently, AP 1 sends another C-TWT request frame to AP 3 and AP 4, indicating Mode-2 R-TWT multi-AP coordination, allowing both AP 3 and AP 4 to participate in the R-TWT multi-AP coordination. In response to the second C-TWT request, AP 3 and AP 4 transmits Accept C-TWT frames to AP 1, respectively. As a result, AP 1, AP 3, and AP 4 become members of an R-TWT multi-AP coordination set.

In an embodiment, in the Type-1 architecture for C-TWT negotiation, an announcement phase may precede the active negotiation between APs.

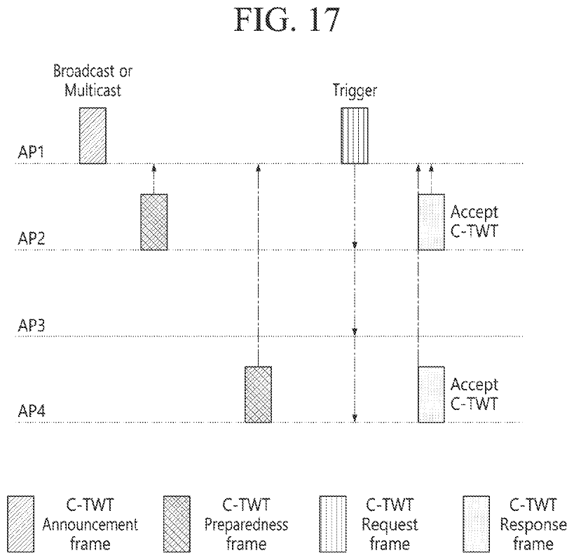

FIG. 17 shows another example of Type-1 architecture for C-TWT negotiation in accordance with an embodiment. The operation depicted in FIG. 17 is for illustration purposes and does not limit the scope of this disclosure to any particular implementations.

In FIG. 17, AP 1 intends to initiate R-TWT multi-AP coordination with other APs (e.g., AP 2, AP 3, and AP 4). The AP 1 transmits a C-TWT announcement frame to identify neighboring APs that are willing to participate in R-TWT multi-AP coordination. The C-TWT announcement frame may be a broadcast frame or a multi-cast frame. In response to the C-TWT announcement frame, AP 2 and AP 4 send C-TWT Preparedness frames to AP 1, indicating their capability to participate in the R-TWT multi-AP coordination. In the C-TWT Preparedness frame, AP 2 and AP 4 may also indicate the Modes of R-TWT multi-AP coordination they support in their BSS. Subsequently, as illustrated in FIG. 16, active negotiation between APs occurs through the exchange of C-TWT Request frame and C-TWT Response frame. In FIG. 17, the C-TWT Request frame may serve a trigger frame that triggers C-TWT Response frames from recipient APs. As shown in FIG. 17, the C-TWT negotiation phase can be preceded by a coordinated TWT announcement phase between APs.

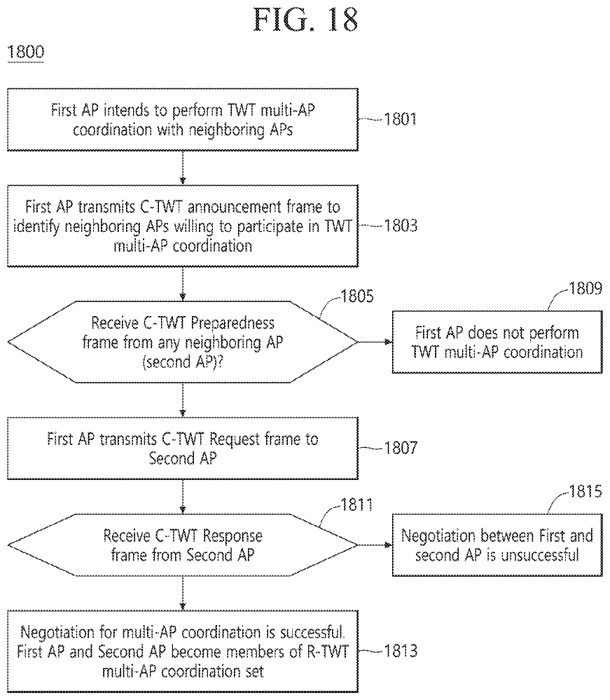

FIG. 18 shows a flow chart of an example operation of TWT multi-AP coordination in accordance with an embodiment. For explanatory and illustration purposes, the example process 1800 may be performed based on the Type-1 architecture for C-TWT negotiation. Although one or more operations are described or shown in particular sequential order, in other embodiments the operations may be rearranged in a different order, which may include performance of multiple operations in at least partially overlapping time periods.

The process 1800 may begin in operation 1801. In operation 1801, a first AP intends to perform TWT multi-AP coordination with neighboring APs. The first AP may be an R-TWT scheduling AP in its BSS.

In operation 1803, the first AP transmits a C-TWT announcement frame to neighboring APs to identify APs that are willing to participate in TWT multi-AP coordination. The C-TWT announcement frame may be a broadcast frame, a multicast frame, or a unicast frame.

In operation 1803, the first AP determines whether it receives a C-TWT Preparedness frame from at least one neighboring AP. When the first AP receives the C-TWT Preparedness frame, the process 1800 proceeds to operation 1807. Otherwise, the process 1800 proceeds to operation 1809.

In operation 1807, the first AP transmits a C-TWT Request frame to the second AP. The C-TWT Preparedness frame may serve as a trigger frame to solicit a C-TWT Response frame from the second AP.

In operation 1809, the first AP does not perform TWT multi-AP coordination.

In operation 1811, the first AP determines whether it receives a C-TWT Response frame from the second AP. When the first AP receives the C-TWT Response frame, the process 1800 proceeds to operation 1813. Otherwise, the process 1800 proceeds to operation 1815. The C-TWT Response frame may be an Accept C-TWT frame.

In operation 1813, the first AP and the second AP successfully negotiate the TWT multi-AP coordination, and the first AP and the second AP become members of the R-TWT multi-AP coordination set.

In operation 1819, the negotiation for TWT multi-AP coordination became unsuccessful.

An example format of the C-TWT announce frame is shown in Table 4 below.

TABLE 4

| Order | Information |
|---|---|
| 1 | Category |
| 2 | TWT Coordination Mode |
| 3 | One or more TWT |

An example format of the C-TWT Preparedness frame is shown in Table 5 below.

TABLE 5

| Order | Information |
|---|---|
| 1 | Category |
| 2 | Unprotected S1G Action |
| 4 | TWT Coordination Mode |
| 5 | One or more TWT |

In an embodiment, negotiations between APs for R-TWT based multi-AP coordination may be controlled by a controller, for example, an R-TWT central controller. This may be referred to as ‘Type-2 architecture for C-TWT negotiation’ in this disclosure.

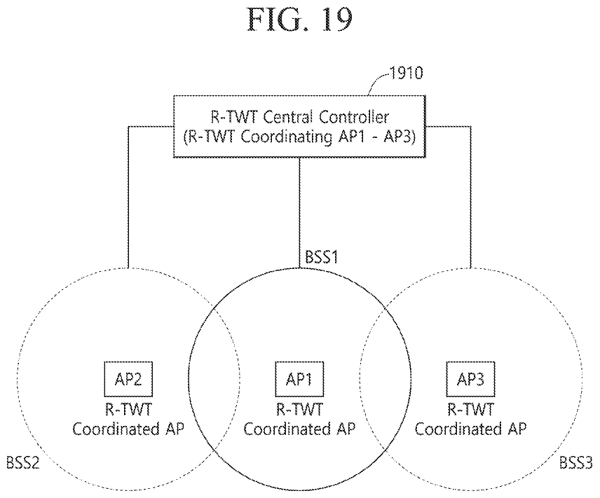

FIG. 19 shows an example of Type-2 architecture for C-TWT negotiation in accordance with an embodiment. The operation depicted in FIG. 19 is for illustration purposes and does not limit the scope of this disclosure to any particular implementations.

In FIG. 19, AP 1, AP 2, and AP 3 establishes BSS 1, BSS 2, and BSS 3, respectively. All three APs are connected to an R-TWT central controller 1910. The R-TWT central controller 1910 coordinates AP1, AP 2, and AP 3 for C-TWT negotiation, and AP 1, AP2, and AP 3 serve as R-TWT coordinated APs.

Referring to FIG. 19, AP 1 may intend to initiate the TWT multi-AP coordination with neighboring APs (e.g., AP 2 and AP 3). In the first place, AP 1 may send an R-TWT coordination request frame to the R-TWT central controller 1910. The R-TWT central controller 1910 may have information for R-TWT schedules of all APs (AP 1, AP 2, and AP 3) that are connected to the R-TWT central controller 1910. Upon receiving the R-TWT coordination request frame from AP 1, the R-TWT central controller 1910 may send a response frame to AP 1 based on the overall network situation. Additionally, if the R-TWT central controller 1910 accepts the coordination request from AP 1, the R-TWT central controller 1910 may send an R-TWT coordination information frame to other APs (e.g., AP 2 and AP 3) that the R-TWT central controller 1910 find suitable for the multi-AP coordination. The R-TWT coordination information frame serves as a trigger frame to solicit APs to participate in the R-TWT coordination initiated by AP 1. In response, the APs (e.g., AP 2 and AP 3) that receive the R-TWT coordination information frame may send an R-TWT coordination acknowledgement frame to the R-TWT central controller 1910 as an acknowledgement for the reception of the R-TWT coordination information frame. Although this embodiment depicted in FIG. 19, as well as other embodiments in this disclosure, is described in terms of R-TWT, the coordination negotiation mechanism may also apply for an individual TWT or broadcast TWT. The formats of the R-TWT coordination request frame and the R-TWT coordination response frame may be the same as the of the C-TWT request frame and the C-TWT announcement frame previously described. An example format of the R-TWT coordination information frame is shown in Table 6.

TABLE 6

| Order | Information |
|---|---|
| 1 | Category |
| 2 | Unprotected S1G Action |
| 4 | TWT Coordination Mode |
| 5 | One or more TWT |

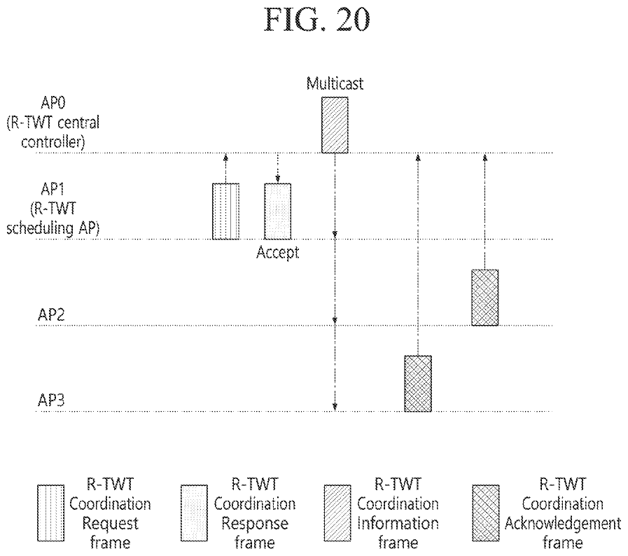

FIG. 20 shows an example timing diagram of Type-2 architecture for C-TWT negotiation in accordance with an embodiment. The operation depicted in FIG. 20 is for illustration purposes and does not limit the scope of this disclosure to any particular implementations. This example depicted in FIG. 20 is based on the topology depicted in FIG. 19.

In FIG. 20, the R-TWT central controller 1910 of FIG. 19 may be referred to as AP 0 for convenience. As illustrated, AP 1 may send an R-TWT Coordination Request frame to AP 0. AP 1 may be an R-TWT scheduling AP in its BSS. In response, AP 0 may accept the request by sending an R-TWT Coordination Response frame to AP 1. Subsequently, AP 0 may transmit an R-TWT Coordination Information frame to AP 2 and AP 3. The R-TWT Coordination Information frame may be a multicast frame, a broadcast frame, or a unicast frame. In response to receiving the R-TWT Coordination Information frame, AP 2 and AP 3 may transmit R-TWT Coordination Acknowledgement frames, respectively.

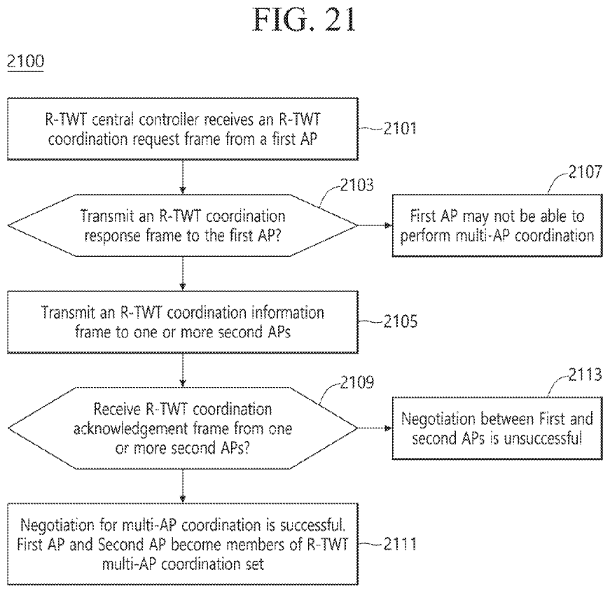

FIG. 21 shows a flow chart of an example operation of TWT multi-AP coordination in accordance with an embodiment. For explanatory and illustration purposes, the example process 2100 may be performed by the R-TWT central controller 1910 depicted in FIG. 19. Although one or more operations are described or shown in particular sequential order, in other embodiments the operations may be rearranged in a different order, which may include performance of multiple operations in at least partially overlapping time periods.

The process 2100 may begin in operation 2101. In operation 2101, the R-TWT central controller receives an R-TWT coordination request frame from a first AP. The R-TWT central controller, serving as an R-TWT coordinating AP, controls the first AP. The first AP may be an R-TWT scheduling AP in its BSS and may intend to perform R-TWT based multi-AP coordination with neighboring APs including a second AP. The R-TWT coordination request frame may include one or more R-TWT elements for which the multi-AP coordination is requested. Then, the process 2100 may proceed to operation 2103.

In operation 2103, the R-TWT central controller determines whether it accepts the R-TWT coordination request. When the R-TWT central controller accepts the R-TWT coordination request, it sends an R-TWT coordination response frame to the first AP, then process 2100 proceeds to operation 2105. Otherwise, the process 2100 proceeds to operation 2107 where the first AP may not be able to perform the requested multi-AP coordination.

In operation 2015, the R-TWT central controller transmits an R-TWT coordination information frame to one or more second APs. The R-TWT coordination information frame serves as a trigger frame including one or more TWT elements to solicit response frames from the one or more second APs.

In operation 2109, the R-TWT central controller determines whether it receives an R-TWT coordination acknowledgement frame from the one or more second APs in response to the R-TWT coordination information frame. If the R-TWT central controller receives an acknowledgement frame from at least one second AP, the process 2100 proceeds to operation 2111. When the R-TWT central controller does not receive an acknowledgement frame from any second AP, the process 1200 proceeds to operation 2113 where the negotiation between first AP and the one or more second APs become unsuccessful.

In operation 2111, the negotiation for the R-TWT based multi-AP coordination become successful. Consequently, the first AP and the at least second AP become members of a multi-AP coordination set controlled by the R-TWT central controller.

In an embodiment, all APs in an R-TWT coordination AP set may be R-TWT scheduling APs in their respective BSSs. In another embodiment, one or more APs in the R-TWT coordination AP set may not be R-TWT scheduling APs in their respective BSSs. In some embodiments, at least one AP in the R-TWT coordinating SP set is an R-TWT scheduling AP in its BSS.

In an embodiment, whether one or more APs in the R-TWT coordinating AP set are R-TWT scheduling APs depends on the observation timeline. For example, during the R-TWT multi-AP negotiation, one or more APs serve as R-TWT scheduling APs. However, after the R-TWT multi-AP coordination negotiation, none of APs may serve as an R-TWT scheduling AP. For example, APs may terminate all their R-TWT schedules in their respective BSSs after the R-TWT multi-AP coordination negotiation.

In an embodiment, if all APs in an R-TWT coordinating AP Set tear down all their R-TWT schedules in their respective BSSs, the R-TWT coordinating AP set may be dismantled. In another embodiment, each AP may send an indication to other APs in the R-TWT coordinating AP set when the AP tears down its R-TWT schedule. In some embodiments, when all APs in the R-TWT coordinating AP set tear down all their R-TWT schedules in their respective BSSs, the APs remain as members of the R-TWT coordinating set.

In an embodiment, when an R-TWT scheduling AP in an R-TWT coordinating AP set tears down the R-TWT schedule, the AP may be no longer a member of the R-TWT coordinating AP set. In another embodiment, even when an R-TWT scheduling AP in an R-TWT coordinating AP set tears down the R-TWT schedule, the AP remains a member of the R-TWT coordinating AP set.

In an embodiment, two or more APs that are not R-TWT scheduling APs may form an R-TWT coordinating AP set.

According to various embodiments in this disclosure, R-TWT based multi-AP coordination can be utilized to maintain seamless latency-sensitive traffic flow.

Although some embodiments in this disclosure are described in terms of R-TWT for explanatory convenience, all of the embodiments are also applicable to general TWT, including broadcast TWT or an individual TWT.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) device in a wireless network, the AP device comprising:
a memory; and
a processor coupled to the memory, the processor configured to cause:
receiving information related to a target wake time (TWT) schedule established in a second basic service set (BSS), wherein the second BSS is established by a second AP device; and
ensuring that a transmission opportunity (TXOP) established in a first BSS ends before a start time of a TWT service period of the TWT schedule established in the second BSS, wherein the first BSS is established by the first AP device.

2. The first AP device of claim 1, wherein the processor is further configured to cause:
abstaining from transmitting a frame to any station associated with the first AP device in the first BSS during the TWT service period.

3. The first AP device of claim 1, wherein the processor is further configured to cause:
abstaining from transmitting a frame to any station associated with the first AP device in the first BSS after the start time of the TWT service period; and
initiating communication with a station associated with the first AP device in a time indicated from the second AP device, wherein the time is before an end time of the TWT service period.

4. The first AP device of claim 1, wherein the TWT schedule established in the second BSS is associated with communication of latency sensitive traffic.

5. The first AP device of claim 1, wherein the process is further configured to cause:
abstaining from transmitting a frame to any station associated with the first AP device in the first BSS after the start time of the TWT service period;
receiving a trigger frame to solicit a response frame from the second AP device; and
initiating communication with a station associated with the first AP device before an end time of the TWT service period.

6. The first AP device of claim 1, wherein the processor is further configured to cause:
receiving a request frame for multi-AP coordination from the second AP device; and
transmitting a response frame indicating acceptance of the request for multi-AP coordination to the second AP device.

7. The first AP device of claim 6, wherein the processor is further configured to cause:
receiving an announcement frame for the multi-AP coordination from the second AP device; and
transmitting a frame indicating capability to participate in the multi-AP coordination to the second AP device.

8. The first AP device of claim 1, wherein information related to the TWT schedule is received from the second AP device.

9. The first AP device of claim 1, wherein the processor is further configured to cause:
transmitting a TWT element including information for the TWT schedule to one or more stations associated with the first AP device.

10. The first AP device of claim 9, wherein the TWT element includes information indicating that the TWT schedule is established in the second BSS.

11. The first AP device of claim 1, wherein the processor is further configured to cause:
receiving a request frame for multi-AP coordination from a controller;
transmitting a response frame indicating acceptance of the request for multi-AP coordination to the controller;
receiving an TWT coordination information including information related to the TWT schedule from the controller; and
transmitting an acknowledgement to the controller in response to the TWT coordination information.

12. A station in a wireless network, the station comprising:
a memory;
a processor coupled to the memory, the process configured to cause:
receiving a target wake time (TWT) element from a first AP device which is associated with the station, wherein the TWT element includes information indicating that a TWT schedule corresponds to the TWT element is established in a second service set (BSS) established by a second AP device; and
ensuring that a transmission opportunity (TXOP) established in a first BSS ends before a start time of a TWT service period of the TWT schedule, wherein the first BSS is established by the first AP device.

13. The station of claim 12, wherein the processor is further configured to cause:
abstaining from transmitting a frame to the first AP device during the TWT service period.

14. The station of claim 12, wherein the processor is further configured to cause:
abstaining from transmitting a frame to the first AP device after the start time of the TWT service period; and
initiating communication with the first AP device in a time indicated from the first AP device, wherein the time is before an end time of the TWT service period.

15. The station of claim 12, wherein the processor is further configured to cause:
abstaining from transmitting a frame to the first AP device after the start time of the TWT service period; and
initiating communication with the first AP device when a trigger frame to solicit a response frame is received from the first AP device before an end time of the TWT service period.

16. The station of claim 12, wherein the TWT schedule established in the second BSS is associated with communication of latency sensitive traffic.

17. A first access point (AP) device in a wireless network, the AP device comprising:
a memory; and
a processor coupled to the memory, the processor configured to cause:
transmitting a request frame for multi-AP coordination to a second AP device, wherein the request frame includes a TWT schedule established in a first basic service set (BSS) and the first BSS is established by the first AP device; and
receiving a response frame indicating acceptance of the multi-AP coordination from the second AP device.

18. The first AP device of claim 17, wherein the processor is further configured to cause:
transmitting an announce frame for the multi-AP coordination to one or more second AP devices, wherein the announce frame includes a mode information for the multi-AP coordination; and
receiving a frame indicating capability to participate in the multi-AP coordination from the second AP device.

19. The first AP device of claim 17, wherein the TWT schedule is associated with communication of latency sensitive traffic.

20. The first AP device of claim 17, wherein the processor is further configured to cause:
transmitting a trigger frame to the second AP device before an end time of a TWT service period corresponding to the TWT schedule, wherein the trigger frame indicates that the second AP is allowed to initiate communication with an associated station in the second BSS.
